(19) United States
(12) Patent Application Publication
(10) Pub. No.: US 2012/0110480 A1
(43) Pub. Date: May 3, 2012

(54) METHOD AND APPARATUS FOR RENDERING A WEB PAGE

(75) Inventor: Pavel KRAVETS, Ashdod (IL)

(73) Assignee: SAP Portals Israel Ltd, Ra'anana (IL)

(21) Appl. No.: 12/916,541

(22) Filed: Oct. 31, 2010

(51) Int. Cl. G06F 3/048

(52) U.S. Cl. 715/760

(57) ABSTRACT

A method and apparatus for rendering a web page comprising multiple widgets, comprising: upon receiving a widget, receiving or associating a priority with the widget, and associating the widget with a hidden area of the page; creating a wrapper for the widget, enabling rendering the widget and communication between the widget and the apparatus; selecting according to the priority, a widget, adding the wrapper to a browser rendering tree, eliminating the widget from the hidden area and adding to a visible area of the page; receiving an event from the wrapper indicating the widget at least partially rendered, or a timeout event; assigning the widget to the hidden area and eliminating from the visible area of the page, and repeating selecting and receiving; provided the event received indicated that the widget at least nearly rendered, determining whether another widget has to be rendered, and if yes repeating selecting and receiving.

### TECHNICAL FIELD

The present disclosure relates to web browsing in general, and to a method and apparatus for rendering a web page, in particular.

### BACKGROUND

Many computer users, and in particular organization employees use a web browser for presenting and using multiple widgets. A web browser is also known is a web client.

The term widget refers to a piece of code and/or data that can be executed and displayed within a web page without requiring additional compilation. The widget can communicate with and receive data from external sources such as web services, databases, or the like. Widgets are often displayed on the user's home page which comes up once the user starts the browser, but can also be displayed at any other time.

The home page of a user may be an enterprise portal, comprising a multiplicity of widgets. The page is a framework for integrating information, people, entities and processes across the organization. The portal provides a secure unified access point, and is designed to aggregate and personalize information.

A user may desire to have the data and processes presented to him on his home page or another page, based on his or her preferences and habits.

However, there is not always sufficient display area to present all data and applications the user wants. In such cases, the information the user may wish to see or use may not always be conveniently accessible. Moreover, some of the displayed items may be inoperative and just waste expensive screen space, for example a business application that cannot connect to the relevant server may present an error message instead of useful information, thus taking up valuable screen space that could have been used by another functioning widget.

Even further, an application may be useful and operative, but may become inoperative at a later time, in which case said application also takes up expensive display area.

There is thus a need in the art for a method and apparatus for composing and maintaining a client side web page.

### SUMMARY

A method and apparatus for rendering a web page.

One aspect of the disclosure relates to a method for rendering a web page displayed by a browser on a display device associated with a computing device, the web page comprising a plurality of widgets executed by a computing platform associated with the display device, the method comprising: upon receiving a widget of the plurality of widgets, receiving or associating a priority with the widget, and associating the widget with a hidden area of the web page; creating a wrapper element for the widget, the wrapper element enabling rendering the widget and enabling communication between the widget and the apparatus; selecting in accordance with the priority, a widget from the multiplicity of widgets, adding the wrapper element associated with the widget to a rendering tree of the browser, eliminating the widget from the hidden area of the web page and adding the widget to a visible area of the web page; receiving an event from the wrapper element indicating the widget is rendered or partially rendered, or a time out event; provided a time-out event was received, assigning the widget to the hidden area of the web page, eliminating the widget from the visible area of the web page, and repeating selecting and receiving steps; and provided the event received indicated that the widget is rendered or nearly rendered, determining whether an additional widget has to be rendered and if yes repeating steps selecting and receiving an event. The method can further comprise receiving an earlier time-out event, and performing selecting step for a second widget. Within the method, the second widget is optionally selected in accordance with a priority indication. The method can further comprise receiving a callback from a collapse event handler or a delete event handler of the widget, raised due to an action of a user, or an exception associated with a widget, and assigning the widget to the hidden area of the web page, eliminating the widget from the visible area of the web page, and repeating selecting and receiving steps for a second widget. Within the method, the wrapper element optionally provides event handler implementations for the widget. The method can further comprise sniffing and routing an event thrown by the widget. Within the method, the event is recognized using a regular expression. The method can further comprise receiving an event thrown by the widget and sending a related event to another widget. The method can further comprise keeping track of events and status of the multiplicity of widgets.

Another aspect of the disclosure relates to an apparatus adapted to be executed by a computing platform for rendering a web page comprising a plurality of widgets, comprising: an event apparatus, comprising: a widget registration controller for keeping track of the plurality of widgets and a prioritization manager for assigning a priority for substantially each of the plurality of widgets; and an event hub for receiving and sending events to and from any of the plurality of widgets; a wrapping manager for creating a wrapper element for a widget from the plurality of widgets, the wrapper element enabling rendering the widget and communication between the widget and the apparatus; and a failover manager for handling fail cases in which the widget failed to render so that another widget is selected for rendering. Within the apparatus, the wrapper element provides event handlers for handling events thrown from the apparatus to the widget. The apparatus can further comprise a sniffer element for catching events thrown by the widget. Within the apparatus, the sniffer element optionally recognizes events thrown by the widget in accordance with a regular expression. The apparatus can further comprise a prioritization manager for selecting the other widget to be rendered.

Yet another aspect of the disclosure relates to a computer readable storage medium containing a set of instructions for a general purpose computer, the set of instructions comprising: upon a client computing platform receiving a widget of a multiplicity of widgets from a server computing platform, receiving or associating a priority with the widget, and associating the widget with a hidden area of a web page; creating a wrapper element for the widget, the wrapper element enabling rendering the widget and enabling communication between the widget and an apparatus; selecting in accordance with the priority, a widget to be rendered from the multiplicity of widgets, adding the wrapper element associated with the widget to a rendering tree of a browser displaying the web page, eliminating the widget from the hidden area of the web page and adding the widget to a visible area of the web page; receiving an event from the wrapper element indicating the widget is rendered or partially rendered, or a time out event; provided a time-out event was received, assigning the widget to the hidden area of the web page, eliminating the widget from the visible area of the web page, and repeating the steps of selecting and receiving an event; and provided the event received indicated that the widget is rendered or nearly rendered, determining whether an additional widget has to be rendered and if yes repeating the steps of selecting and receiving an event. Within the computer readable storage medium the set of instructions can further comprise receiving an earlier time-out event, and performing selection step for a second widget. Within the computer readable storage medium, the second widget is optionally selected in accordance with a is priority indication. Within the computer readable storage medium, the set of instructions can further comprise receiving a callback from a collapse event handler or a delete event handler of the widget, raised due to an action of a user, or an exception associated with a widget, and assigning the widget to the hidden area of the web page, eliminating the widget from the visible area of the web page, and repeating steps selecting and receiving event for a second widget. Within the computer readable storage medium, the wrapper element optionally provides event handler implementations for the widget. Within the computer readable storage medium, the set of instructions can further comprise sniffing and routing an event thrown by the widget.

### BRIEF DESCRIPTION OF THE DRAWINGS

The present disclosure will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic view of the data structure representing a client page, in accordance with the disclosure;

FIG. 2 is a schematic block diagram of the components of a page authoring framework, in accordance with the disclosure; and

FIG. 3 is a flowchart of the main steps in a method for page authoring, in accordance with the disclosure.

### DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to generate and present a client web page comprising a plurality or multiplicity of widgets. The client web page is displayed on a display device such as a CRT or LCD, and the widgets are processed by a computing platform associated with the display device.

One technical solution can be implemented as a script or an executable which is executed within a browser capable of presenting web pages.

A technical aspect of the solution can relate to an apparatus which communicates with a server to receive the widgets to be presented to a user by the browser as part of the web page displayed on a screen.

The apparatus can prioritize the widgets and subsequently the widgets can be displayed in accordance with the priority. The priority may take into account factors such as: the user's preferences, the user's habits, predetermined order associated with a group or a role of the user, graphic characteristics of the widget such as size, physical characteristics such as screen size, and possibly others.

The apparatus then creates two collections, one representing the visible area of the page, and the other representing a hidden area of the page.

In some embodiments of the subject matter, items are initially assigned to the hidden area. The apparatus assigns widgets to the visible area of the page in accordance with their priority and the available space. The items that can not fit within the page remain within the hidden area.

In Some embodiments of the subject matter, each widget assigned to the visible area is added to the browser's rendering tree. The widgets assigned to the hidden area are not added to the browser's rendering tree, thus eliminating all associated rendering time or other costs.

In some embodiments of the subject matter, when the widget is or becomes inoperative, for example receives an error message from a server from which it should receive information, collapsed by a user, crashes or the like, it is automatically replaced with the next highest priority widget available in the hidden area, or the next preassigned widget.

One effect of the present subject matter is that the web page presents the widgets which are of highest priority for the user, and are also available and operative.

In some embodiments of the subject matter, in order to improve the user experience and give the user a sense of fast loading of the web page, the widgets can be added to the browser's rendering tree such that each widget is completely rendered or at least partially rendered before the next one starts to render.

Since the widgets are managed by the apparatus, the apparatus can also receive notifications about events sent to or from any of the widgets. Once the apparatus receives such an event, the apparatus can facilitate mashup, i.e., updating one displayed application due to changes caused or reflected by another displayed application.

The apparatus can be implemented in any desired programming language which can be executed by a browser, such as JavaScript, HTML, DHTML or the like.

In typical usage, the apparatus is executed by the browser of a client computing platform in a computer network. The client computing platform is connected to one or more server computing platforms, via any communication channel, such as Wide Area Network, Local Area Network, wireless, or the like. Any of the client computing platform or the server computing platforms is equipped with a CPU, memory and communication ports.

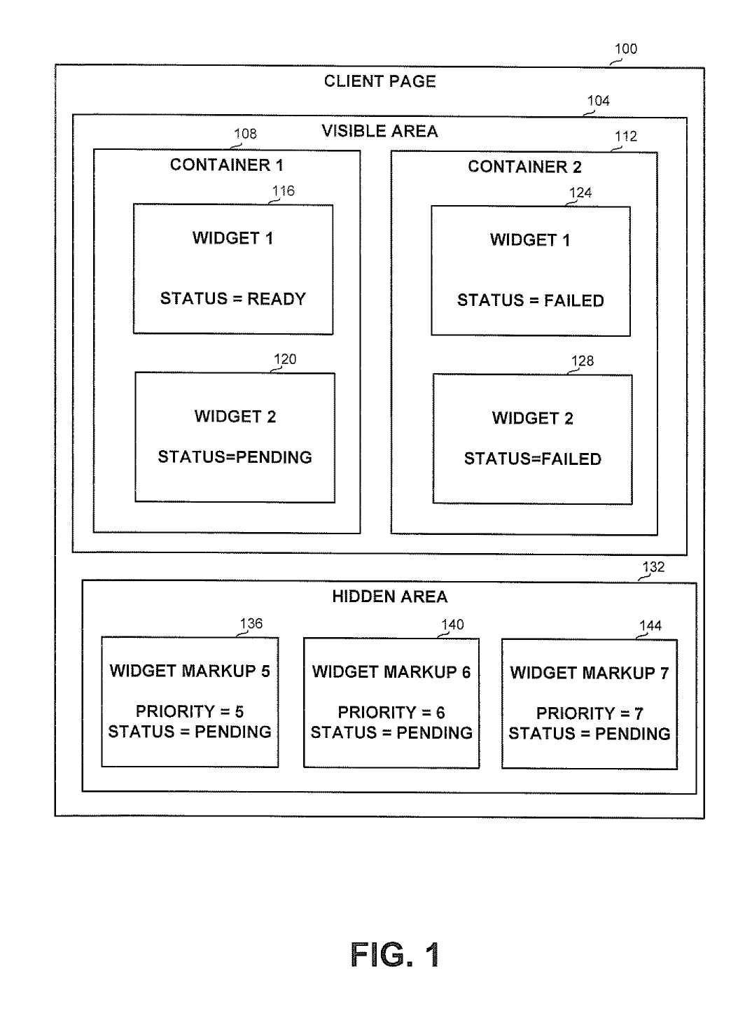

Referring now to FIG. 1, showing a block diagram of an exemplary state of the data structure kept by the apparatus for the widgets.

The data structure, generally referenced 100, describes the memory contents associated with the client page. Data structure 100 comprises visible area 104 and hidden area 132. Visible area 104 optionally comprises data such as the available screen space, resolution, maximal or minimal number of items the user would like to see at any given time, or the like. Visible area 104 optionally comprises or points at multiple containers, such as container 1 (108) or container 2 (112). Each container is associated with a particular area of the screen, and comprises the dimensions, location, or other characteristics of the particular area, as well as reference to the widgets container therein. It will be appreciated that the number of containers, their sizes and locations on the screen can vary between sessions, and that in some embodiments containers can be manipulated, for example added or deleted at any time.

In some alternative embodiments, containers are not used and the visible area contains or references the widgets directly.

Container 1 (108) comprises references to widget 1 (116) whose status is “ready” and widget 2 (120) whose status is “pending”. Therefore, widget 1 (116) is displayed and widget 2 (120) is still in the process of rendering.

Container 2 (112) comprises references to widget 3 (124) and widget 4 (128), the status of both is “failed”. Therefore, in some embodiments of the subject matter, widget 3 (124) and widget 4 (128) will be replaced by other widgets, as detailed below.

Hidden area 132 comprises widget 5 (136) having priority equal to 5, widget 6 (140) having priority equal to 6 and widget 7 (144) having priority equal to 7, all three of which are in “pending” state. The use of numbering of priority levels is provided for the sake of convenience and any other method for is prioritizing can be used.

Once the status of a widget of the visible area becomes “failed”, the widget is eliminated from the visible area 104 and is moved to hidden area 132. The elimination of a widget may free screen space, so the widget having the highest priority (or lowest priority, depending whether the higher priority is expressed by a higher or a lower number) is eliminated from hidden area 132 and added, possibly within a container, into visible area 104.

In some embodiments of the subject matter, when the status of widget 3 (124) becomes “failed”, it is eliminated from container 2 (112) of visible area 104, moved to hidden area 132, and the widget having highest priority within hidden area 132, being for example widget 5 (136) is moved to visible area 104, possibly but not necessarily within container 1 (108). Widget 3 (124) is removed from the rendering tree of the browser, and widget 5 (136) is added to the rendering tree, and is rendered on the web page.

Visible area 104 contains the displayed widgets, while hidden area 132 contains the widgets that are not displayed, whether they are of lower priority than the displayed widgets, because the displayed widgets are malfunctioning, possibly as a result of the user collapsing or deleting them, or because of any other reason.

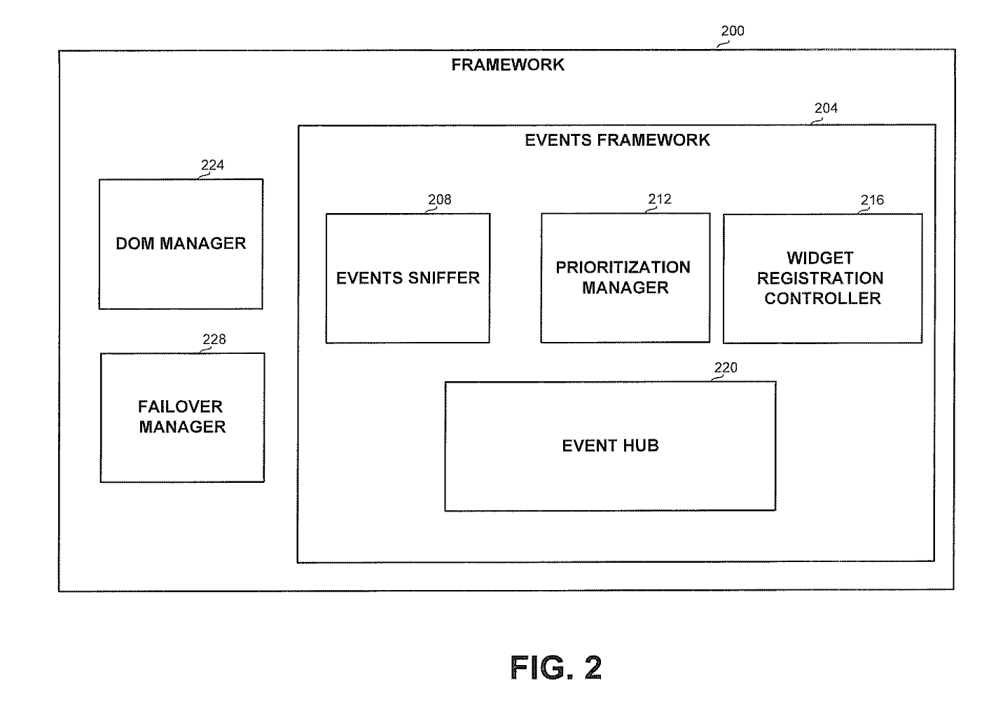

Reference is now made to FIG. 2 showing a block diagram of an exemplary implementation of an apparatus for automatically composing a web page.

The apparatus for automatically composing a web page, generally referenced 200 comprise an events apparatus 204 for registering and handling events, an object presentation manager such as a DOM manager 224 and failover manager 228.

Events apparatus 204 is responsible for registering and routing the events sent to and from the widgets. In some embodiments, events apparatus 204 comprises event sniffer 208, for sniffing events sent to or from the widgets. If the events are unknown to the apparatus, i.e. the widgets that sends the event did not register the events with the apparatus, then event sniffer 208 will try to match an event to a known event that will be handled. The matching can be done, for example by matching the event name or a part thereof as a part of a regular expression.

Events apparatus 204 further comprises prioritization manager 212 selecting a widget to be rendered from the hidden area, in accordance with its priorities. In some embodiments of the subject matter, the priority of the widget is set by the server from which the widgets are sent. In some other embodiments of the subject matter, prioritization manager 212 is also responsible for determining priorities of widgets in accordance with user's preferences, group settings, user's usage history or the like. The priorities assigned to the different widgets determine the order in which the widgets are rendered.

Events apparatus 204 also comprises widget registration controller 216 for registering the widgets, either with the hidden area or the visible area, such that the widget registration controller 216 will have access to all widgets on the hidden area and the visible area. The registration enables events apparatus 204 to receive and send events from and to all widgets.

Events apparatus 204 further comprises event hub 220 for receiving and dispatching the events to the widgets that registered using widgets registration controller 216. Event hub 220 will also receive and send non-registered events, if such events were recognized by event sniffer 208.

Apparatus 200 comprises wrapping manager 224 for creating a wrapper element, for example an HTML DOM element, which provides a basic user interface, sometimes referred to as a “tray” or decorator, which decorates, i.e., provides user interface elements for the widget, such as a frame, a close button, a minimize button or the like.

The tray, as provided by the environment and compound from DOM elements, provides a mechanism for sending the required events to a event hub. F, for example a “close” event is sent to the event hub when the close button is pressed. The widget will be removed from the rendering tree and the widget registration controller will provide a new widget to be rendered. Each widget may optionally communicate with the apparatus by client side Application Program Interfaces (APIs), like providing the status and priority by getPriority and, getStatus methods, which can be implemented, for example, by JavaScript.

Yet another component of apparatus 200 is failover manager 228 for handling problems and changes, such as a widget that does not complete its rendering in a predetermined time, a widget raising an exception, or the like. Failover manager 228 is responsible for removing the problematic widget from the visible area and for selecting another widget to be rendered from the hidden area.

It will be appreciated that apparatus 200 may comprise additional elements and components, such as communication management components, log keeping components, or the like.

The apparatus 200 components can be implemented as one or more inter-related collections of computer instructions, such as executables, scripts, libraries, functions, methods, or the like, programmed in any desired programming language or scripting language and under any development environment.

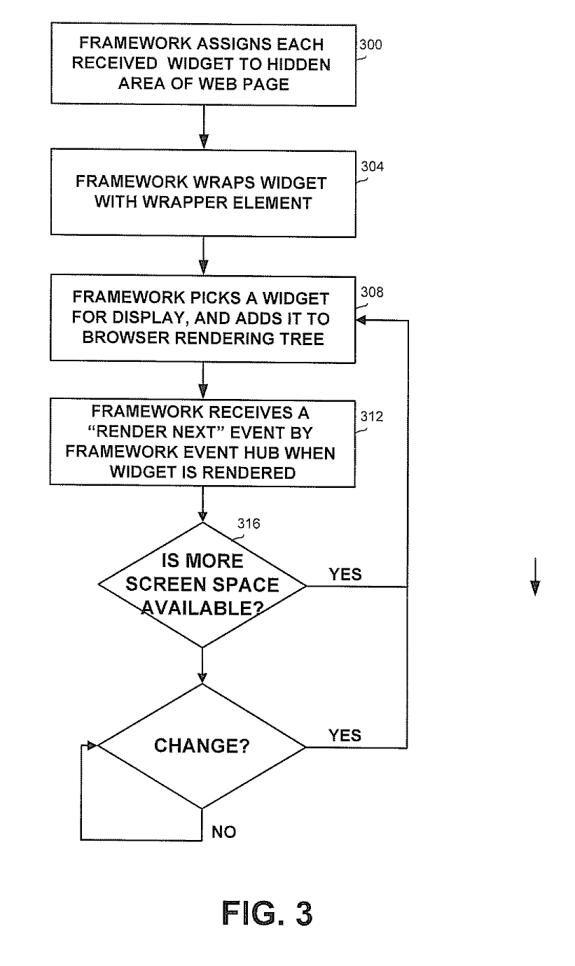

Referring now to FIG. 3, showing a flowchart of the main steps in a method for composing a web page on a client computing platform.

In some embodiments, when the page starts to load, all widgets are received from the server, and each widget can contain the entire markup, i.e., the widget may be a fully rendered component with all its user interface elements, bur it is not visualized. Alternatively, each widget can contain only a Uniform Resource Locator (URL) to the server. The apparatus by default does not store anything on the client side and indicate that all widgets are received from the server, but it is possible to set a flag named for example clientSidePersistent to be true, so that the apparatus will attempt to store the content on the client side, as persistent storage. The storage can be implemented in a number of ways, for example by using browser cookies, thus supporting offline mode.

At 300, the apparatus assigns each of the widgets received, whether sent from the server or already existing within the browser or other location, i.e., the widgets listed in the web page description, to the hidden area of the browser. Thus, the widget is not part of the browser rendering tree and causes no performance costs.

In some embodiments of the subject matter, each widget arrives with a priority assigned to it by the server. In some other alternative embodiments of the subject matter, the priority is assigned to each widget by the apparatus, for example in accordance with the arrival order of the widgets. The priority is assigned in accordance with the user's preferences, user's past actions, system settings for the user, a group the user belongs to, or the like. In some yet additional embodiments of the subject matter, a widget is not assigned a priority and in such case, the apparatus assumes a predetermined priority. At this stage, the widgets are not added to the rendering tree but are rather kept at the hidden area, for example as strings.

At 304, the apparatus wraps each widget within the hidden area with a wrapper element such as an HTML DOM element, or another standard object which enables to get, add, delete or change an HTML element. In some embodiments of the subject matter wrapping of each widget is performed when the page is initially loaded.

Each wrapper element implements the methods of Get/Set status wherein the status can be “ready”, “rendering”, “failed”, “pending” and optionally additional ones, and Get the priority for the associated widget. In some embodiments, the status can be changed dynamically, in which case a Get status method is also implemented.

Each widget, through its wrapper also exposes all required events which can be thrown to the widget once it is rendered, such as an event notifying the widget it has been closed, deleted, minimized, or the like.

In some embodiments of the subject matter, the event handler implementation can be avoided, such that no particular action is taken by the widget on such event, and the default handling as provided by the wrapper object apparatus takes place.

In accordance with some other embodiments of the subject matter, the implementer can implement the event handler in accordance with his or her preferences, for example issue a notification or verification message to the end user upon the receipt of an event such as when the widget is closed. The event handler can also call any method and in particular a callback method of the apparatus when handling the event. For example the widget can call a method of the apparatus which renders the next widget according to some order.

A widget programmer or developer can influence the rendering order which is generally set by the apparatus, by setting a predetermined value in a “priority” field or providing a specific implementation for the getPriority method. If no priority is specified, and not getPriority method is implemented, the apparatus will determine the priority by the arrival order, usage frequency as determined over time, by failure count or any other factor or a combination thereof.

In some embodiments of the subject matter, the implemented event handler can throw known events to the apparatus rather than call the apparatus's methods. The sniffer component of the apparatus will then catch the events and call the relevant event handler of the apparatus.

In yet other embodiments of the subject matter, the widget's event handler can throw any event, including unknown events to the apparatus. These events are caught by the sniffer and the apparatus attempt to match such events to relevant handlers, for example by trying to match regular expressions. For example, an unknown event whose name contains the string “delete” may be interpreted and handled as a delete event.

In some embodiments of the subject matter, during initialization the apparatus also binds widgets to the event apparatus, such that the widgets receive the relevant notifications through their wrappers, for example when the widgets are being loaded. In this approach, a tray is provided for each widget, which may provide default framework events, such as delete, collapse or others. Alternatively, a developer may provide custom event handlers which will be bound to the relevant button or user interface element, so when the element is activated, for example a button is clicked, the event handler will be called.

In other embodiments of the subject matter, during initialization the widgets are registered with the widget registration controller, so that the widget registration controller can keep track of the widgets in the hidden area and in the visible area, and make sure the widgets receive events they register for.

At 308 the apparatus picks up an element associated with a widget from the hidden area, in accordance with the applicable logic. The logic may relate to any one or more considerations such as but not limited to: available screen space, priority of the widget, item load time, usage history of the item by the user, or the like. The apparatus then adds the element to the browser rendering tree, and assigns a placeholder for it on the web page, so that the element is rendered on the placeholder.

The location of the placeholder can also be configurable, for example the place holder for the highest priority element can be the top left corner of the page, a particular rendering order, or the like. The browser may then, depending on the nature of the widget, send one or more requests to the server and receive one or more responses, upon which the widget is rendered.

At 312, when the widget is rendered, it is removed from the hidden area, and throws a RenderNext event to event hub 220. In some embodiments, the RenderNext event may be thrown prior to complete rendering, for example when the widget is nearly fully rendered, in order to accelerate rendering and avoid cases in which a slow rendering widget holds up all subsequent widgets.

At 316, upon receipt of the RenderNext event, The event hub will call the widget registration controller 216 to get the next widget from the hidden area in to accordance with the priorities, and will send an event to the widget using event hub 220. The widget registration controller determines whether another widget is to be displayed, e.g. whether there is free screen space, and if there is control goes back to 308, in which another widget is selected from the hidden area. The location of the next widget is selected in accordance with the user's preferences or any other schema, such as clockwise, left-to-right and top-to-bottom, or the like.

If no additional widgets are to be loaded, then at 320, the apparatus waits until a change occurs. The change can be a user collapsing or deleting a widget, a widget becoming useless for example due to loss of connection to the server, or the like. Once a change occurs, control returns to 308 and a new widget is selected for rendering.

In some embodiments, the apparatus employs a failover mechanism. One non-limiting exemplary failover mechanism is a “two level timeout” approach. After a predetermined time has passed since a widget was added to the rendering tree and has not finished rendering, a second widget is added to the rendering tree and starts rendering in parallel to the first one. Once a second predetermined time has passed, the first widget will be removed from the rendering tree and from the visible area and be assigned to the hidden area, and another widget will be selected from the hidden area. In the present example, assuming the second widget rendering is completed, the second widget will be displayed to the user.

If a problem with the widget avoided its rendering and an exception was raised, the apparatus will recognize the exception and a new widget will be selected for rendering.

In some embodiments of the subject matter, all exceptions and timeout events are tracked and logged, so that in addition to seeing the widgets that loaded successfully, the user can also see indications to the failed widgets, indications to the widgets that were not loaded due to lack of screen space, or the like. The tracing or log file can be kept in memory and presented to a user, and/or stored in a persistent storage device.

The central management of the events enables mashup, i.e., the update of a particular widget due to a change that occurred in another widget. For example, if a new order was placed using an order management widget, and an agent compensation widget was registered for such event, the agent compensation will receive the event and may be updated automatically.

The disclosed method and apparatus provide for presenting a web page comprising a multiplicity of widgets. The apparatus may assign priority to each widget, such that the widgets which were assigned the highest priorities are displayed before widgets having lower priority. If a widget is inoperative or the user deletes or collapses it, the widget having the highest priority that has not been displayed yet, is displayed, thus providing for the most effective usage of the display area.

In some embodiments of the subject matter, the widgets are added to the rendering tree of the web page one at a time, so that each widget starts rendering after the previous one is fully or substantially fully displayed. Some exceptions occur on inoperative or particularly slow widgets. Displaying the widgets one after the other provides for higher satisfaction by users because the rendering time is shorter, even if some of the widgets would not render, the user would not be required to wait due to the rendering tree mixing elements from different widgets.

It will be appreciated that the method and apparatus can be used in a variety of applications in which the number of items that can be presented is smaller than the available number of items. In one example, the method and apparatus can be used in a social network application in which the number of posts or messages is too large. The system and apparatus can then be used for selecting the messages or posts that are more important for the user, in accordance with the user's preferences. For example posts from persons the user often communicates with will receive higher priority, posts that are found to be related to a topic the user is interested in, found for example by text analysis methods, will receive higher priority, or the like.

It will be appreciated by a person skilled in the art that the disclosed method and apparatus are exemplary only and that multiple other implementations and variations of the method and apparatus can be designed without deviating from the disclosure. It will be further appreciated that components of the apparatus or steps of the method can be implemented using proprietary or commercial products.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this disclosure, but only by the claims that follow.

What is claimed is:

1. A method for rendering a web page displayed by a browser on a display device associated with a computing device, the web page comprising a plurality of widgets executed by a computing platform associated with the display device, the method comprising:
a. upon receiving a widget of the plurality of widgets, receiving or associating a priority with the widget, and associating the widget with a hidden area of the web page;
b. creating a wrapper element for the widget, the wrapper element enabling rendering the widget and enabling communication between the widget and the apparatus;
c. selecting in accordance with the priority, a widget from the multiplicity of widgets, adding the wrapper element associated with the widget to a rendering tree of the browser, eliminating the widget from the hidden area of the web page and adding the widget to a visible area of the web page;
d. receiving an event from the wrapper element indicating the widget is rendered or partially rendered, or a time out event;
e. provided a time-out event was received on step (d), assigning the widget to the hidden area of the web page, eliminating the widget from the visible area of the web page, and repeating steps (c) and (d); and
f. provided the event received on step (d) indicated that the widget is rendered or nearly rendered, determining whether an additional widget has to be rendered and if yes repeating steps (c) and (d).

2. The method of claim 1 further comprising:
receiving an earlier time-out event, and
performing step (c) for a second widget.

3. The method of claim 2 wherein the second widget is selected in accordance with a priority indication.

4. The method of claim 1 further comprising:
receiving a callback from a collapse event handler or a delete event handler of the widget, raised due to an action of a user, or an exception associated with a widget, and
assigning the widget to the hidden area of the web page, eliminating the widget from the visible area of the web page, and repeating steps (c) and (d) for a second widget.

5. The method of claim 1 wherein the wrapper element provides event handler implementations for the widget.

6. The method of claim 1 further comprising sniffing and routing an event thrown by the widget.

7. The method of claim 6 wherein the event is recognized using a regular expression.

8. The method of claim 1 further comprising receiving an event thrown by the widget and sending a related event to another widget.

9. The method of claim 6 further comprising keeping track of events and status of the multiplicity of widgets.

10. An apparatus adapted to be executed by a computing platform for rendering a web page comprising a plurality of widgets, comprising:
an event apparatus, comprising:
a widget registration controller for keeping track of the plurality of widgets and
a prioritization manager for assigning a priority for substantially each of the plurality of widgets; and
an event hub for receiving and sending events to and from any of the plurality of widgets;
a wrapping manager for creating a wrapper element for a widget from the plurality of widgets, the wrapper element enabling rendering the widget and communication between the widget and the apparatus; and
a failover manager for handling fail cases in which the widget failed to render so that another widget is selected for rendering.

11. The apparatus of claim 10 wherein the wrapper element provides event handlers for handling events thrown from the apparatus to the widget.

12. The apparatus of claim 10 further comprising a sniffer element for catching events thrown by the widget.

13. The apparatus of claim 12 wherein the sniffer element recognizes events thrown by the widget in accordance with a regular expression.

14. The apparatus of claim 12 further comprising a prioritization manager for selecting the other widget to be rendered.

15. A computer readable storage medium containing a set of instructions for a general purpose computer, the set of instructions comprising:
a) upon a client computing platform receiving a widget of a multiplicity of widgets from a server computing platform, receiving or associating a priority with the widget, and associating the widget with a hidden area of a web page;
b) creating a wrapper element for the widget, the wrapper element enabling rendering the widget and enabling communication between the widget and an apparatus;
c) selecting in accordance with the priority, a widget to be rendered from the multiplicity of widgets, adding the wrapper element associated with the widget to a rendering tree of a browser displaying the web page, eliminating the widget from the hidden area of the web page and adding the widget to a visible area of the web page;
d) receiving an event from the wrapper element indicating the widget is rendered or partially rendered, or a time out event;
e) provided a time-out event was received on step (d), assigning the widget to the hidden area of the web page, eliminating the widget from the visible area of the web page, and repeating steps (c) and (d); and
f) provided the event received on step (d) indicated that the widget is rendered or nearly rendered, determining whether an additional widget has to be rendered and if yes repeating steps (c) and (d).

16. The computer readable storage medium of claim 15 wherein the set of instructions further comprises:
receiving an earlier time-out event, and
to performing step (c) for a second widget.

17. The computer readable storage medium of claim 16 wherein the second widget is selected in accordance with a priority indication.

18. The computer readable storage medium of claim 15 wherein the set of instructions further comprises:
receiving a callback from a collapse event handler or a delete event handler of the widget, raised due to an action of a user, or an exception associated with a widget, and
assigning the widget to the hidden area of the web page, eliminating the widget from the visible area of the web page, and repeating steps (c) and (d) for a second widget.

19. The computer readable storage medium of claim 15 wherein the wrapper element provides event handler implementations for the widget.

20. The computer readable storage medium of claim 15 wherein the set of instructions further comprises sniffing and routing an event thrown by the widget.
